(19) United States
(12) Patent Application Publication
(10) Pub. No.: US 2023/0143362 A1
(43) Pub. Date: May 11, 2023

(54) MICROELECTROMECHANICAL OSCILLATORS PRODUCING UNIQUE IDENTIFIERS

(71) Applicants: ALLIANCE FOR SUSTAINABLE ENERGY, LLC, Golden, CO (US); UT-BATTELLE, LLC, Oak Ridge, TN (US)

(72) Inventors: Panagiotis George DATSKOS, Golden, CO (US); Nickolay LAVRIK, Knoxville, TN (US)

(21) Appl. No.: 17/910,697

(22) PCT Filed: Mar. 15, 2021
(86) PCT No.: PCT/US21/22290

§ 371 Date: Sep. 9, 2022

Related U.S. Application Data
(60) Provisional application No. 62/988,961, filed on Mar. 13, 2020.

(51) Int. Cl. H04L 9/08; H04L 9/32; H03H 3/007; G06K 19/067

(52) U.S. Cl. CPC H04L 9/0866; H04L 9/3278; H03H 3/0077; G06K 19/067

(57) ABSTRACT

Described herein is using an array of microelectromechanical systems (MEMS) oscillators to produce unique identifiers. At least some of the MEMS oscillators will “couple” or influence each other when exposed to an external stimulus, such that the frequency of the device is not equal to the combination of individual MEMS oscillator frequencies. The frequency of the device provides a unique “fingerprint” that allows the device to be identified with accuracy but is incredibly difficult to copy, meaning the response may be a physical unclonable function (PUF).

### CROSS-REFERENCE TO RELATED APPLICATIONS

This application claims priority from U.S. Provisional Patent Application No. 62/988,961, filed on Mar. 13, 2020 the contents of which are incorporated herein by reference in their entirety.

### CONTRACTUAL ORIGIN

This invention was made with government support under Contract No. DE-AC36-08GO28308 awarded by the U.S. Department of Energy. The United States government has certain rights in this invention.

### SUMMARY

An aspect of the present disclosure is a method of creating a unique identifier, the method including fabricating a plurality of oscillators, adhering a weight on at least one oscillator within the plurality of oscillators, and recognizing a response of the plurality of oscillators as the unique identifier; wherein the plurality of oscillators comprises at least one of a cantilever or a bridge, the weight adheres to at least one of the oscillators within the plurality of oscillators, and the response comprises the frequency of the plurality of oscillators. In some embodiments, the fabricating includes depositing at least one structural layer on a base and etching the plurality of oscillators within the at least one structural layer; wherein the at least one structural layer includes silicon, and the etching is performed using anisotropic potassium hydroxide (KOH). In some embodiments, the adhering includes at least one of dewetting or dealloying. In some embodiments, dewetting includes depositing a thin film of the weight on at least one oscillator within the plurality of oscillators and heating the plurality of oscillators resulting in the adhering of the weight on the at least one oscillator within the plurality of oscillators. In some embodiments, dealloying includes depositing the weight on at least one oscillator within the plurality of oscillators, and selectively removing a portion of the weight resulting in the adhering of the weight on the at least one oscillator within the plurality of oscillators. In some embodiments, the weight includes at least one of platinum (Pt), silver (Ag), gold (Au), silicon (Si), zinc (Zn), copper (Cu), or cobalt (Co). In some embodiments, each oscillator within the plurality of oscillators comprises a length, a width, and a thickness. In some embodiments, the plurality of oscillators does not have a uniform length.

In some embodiments, the plurality of oscillators does not have a uniform width. In some embodiments, the plurality of oscillators does not have a uniform thickness. In some embodiments, the recognizing includes measuring a frequency response of the plurality of oscillators. In some embodiments, the measuring includes exciting the plurality of oscillators using an external stimulus resulting in the frequency response and detecting the frequency response of the plurality of oscillators. In some embodiments, the detecting includes generating an optical readout of the frequency response. In some embodiments, the generating includes using at least one laser to illuminate the plurality of oscillators and capturing the frequency response using a detector capable of showing the optical readout.

An aspect of the present disclosure is a device for creating a unique identifier, the device includes a plurality of oscillators, and a weight attached to at least one oscillator within the plurality of oscillators, wherein the device is configured to generate a frequency response as a result of an external stimulus, and the frequency response is the unique identifier.

### BACKGROUND

In many residential, commercial, and military applications proper functioning and operation of devices is crucial. It is increasingly important to ensure that electronic components and devices perform as designed for their full-specified lifetime. With the increasing number of counterfeit components appearing in important industrial, commercial, and security applications, it is vital to safeguard and secure the supply of genuine tested and reliable components. Unique identifiers attached to products can allow manufacturers and consumers to confirm the products are authentic and prevent consumers from being swindled. The International Chamber of Commerce projects that the negative impacts of counterfeiting and piracy may drain over $4.2 trillion USD from the global economy and put over 5.4 million jobs at risk by 2022. Thus, there remains a need for unique identifiers which are both easy to manufacture and incredibly difficult to copy.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 illustrates two exemplary devices for creating a unique identifier, according to some aspects of the present disclosure.

FIG. 2 illustrates a device including a plurality of bridge oscillators for creating a unique identifier, according to some aspects of the present disclosure.

FIG. 3 illustrates a device including a plurality of cantilever oscillators for creating a unique identifier, according to some aspects of the present disclosure.

FIG. 4 illustrates a method of making a unique identifier, according to some aspects of the present disclosure.

FIG. 5 illustrates a system for determining an optical readout of a device for creating a unique identifier, according to aspects of the present disclosure.

FIG. 6 illustrates frequency responses of oscillators within a device for creating a unique identifier and the total response of the device itself, according to some aspects of the present disclosure.

FIG. 7 illustrates a comparison between ambient and acoustic excitation for a device for creating a unique identifier, according to some aspects of the present disclosure.

### REFERENCE NUMBERS

100 . . . device
110 . . . oscillator
120 . . . anchor
130 . . . base
400 . . . method
405 . . . fabricating
410 . . . adhering
415 . . . recognizing
500 . . . system
505 . . . laser
510 . . . detector
515 . . . base
520 . . . generator
525 . . . processor

### DETAILED DESCRIPTION

The present disclosure may address one or more of the problems and deficiencies of the prior art discussed above. However, it is contemplated that some embodiments as disclosed herein may prove useful in addressing other problems and deficiencies in a number of technical areas. Therefore, the embodiments described herein should not necessarily be construed as limited to addressing any of the particular problems or deficiencies discussed herein.

References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The present disclosure relates to using an array of microelectromechanical systems (MEMS) oscillators to produce unique identifiers. The devices may be adhered to products and the unique identifiers produced by the devices may be used to determine the authenticity of the product and prevent counterfeit. The devices described herein provide periodic oscillating responses in response to various external stimuli, which may be recorded and/or recognized optically. In some embodiments of the present disclosure, the individual MEMS oscillators may in the form of a cantilever and/or a bridge. The cantilever and/or bridge oscillates (i.e., vibrates) at a characteristic frequency when exposed to an external stimulus, such as sound (i.e., an audio stimulus), light (i.e., an optical stimulus), and/or heat (i.e., a thermal stimulus). At least some of the MEMS oscillators in a device, will “couple” or influence each other when exposed to an external stimulus, such that the frequency of the device is not equal to the combination of individual oscillator frequencies. The frequency of the device provides a unique “fingerprint” that allows the device to be identified with significant accuracy, but which is incredibly difficult (if not impossible) to copy, meaning the response can be used as a unique identifier and/or a physical unclonable function (PUF). Examples of products that can benefit from the use of the devices described herein include consumer goods, pharmaceuticals, tickets (such as airline tickets, entry tickets to sporting events or performance arts), identification badges, food products, and many others.

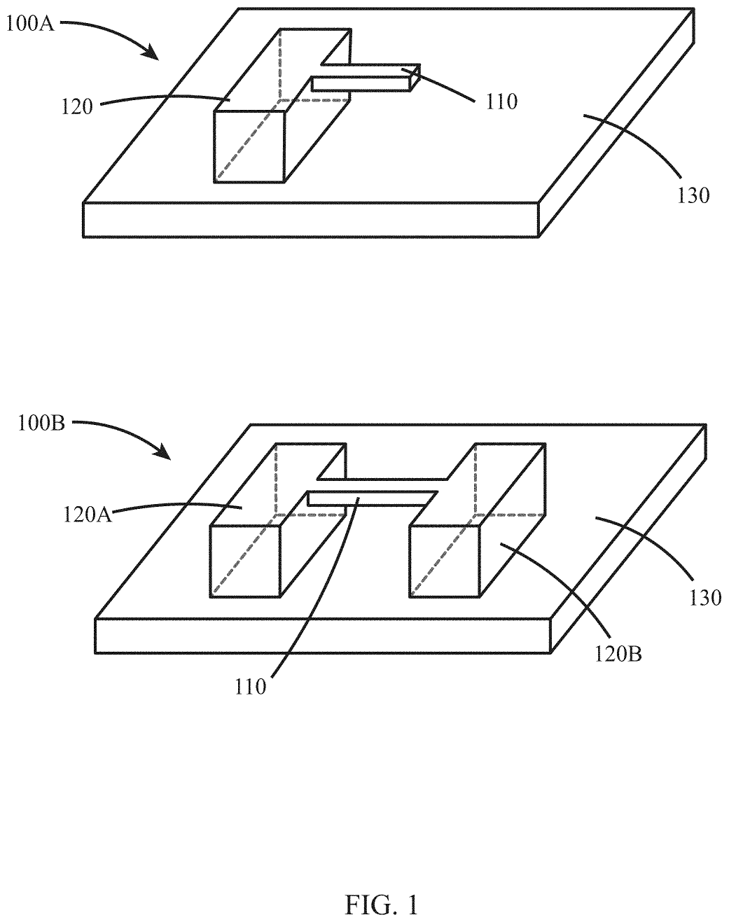

FIG. 1 illustrates two exemplary MEMS oscillators which may in combination with other MEMS oscillators act as PUFs, according to some aspects of the present disclosure. Each of the two devices (100A and 100B), includes an oscillator 110 physically connected to at least one anchor 120 that is physically mounted on a base 130. An oscillator 110, as the name implies, oscillates (i.e., resonates) at a specific frequency when exposed to a stimulus. Additionally, the oscillator 110 resonates at a specific frequency when no stimulus is present (i.e., when the device is exposed to ambient conditions). This frequency at ambient conditions is referred to as the resonance frequency herein and is induced by Brownian motion. The stimulus may be referred to as an input and the resultant frequency emitted by the oscillator 110 may be referred to as an output. The output of the device (e.g., a specific frequency) that provides the desired functional result, a unique identifier that can help identify with a high level of certainty the protected device from other devices (i.e., distinguish a genuine device from a fake and/or counterfeit device).

The first exemplary MEMS oscillator device, 100A, is constructed of an oscillator 110 connected to an anchor 120 and a base 130. When the device 100A is exposed to an input, the oscillator 110 resonates, generating a frequency response (or output). The device 100A shown in FIG. 1 may be referred to as a cantilever.

The second exemplary MEMS oscillator device 100B shown in FIG. 1, is constructed of a single oscillator 110 positioned between two anchors (120A and 120B), with both anchors (120A and 120B) positioned on a base 130. Thus, when the device 100A is exposed to an input, the device 100A generates a single output (e.g., frequency). The second device 100B may be referred to as a bridge.

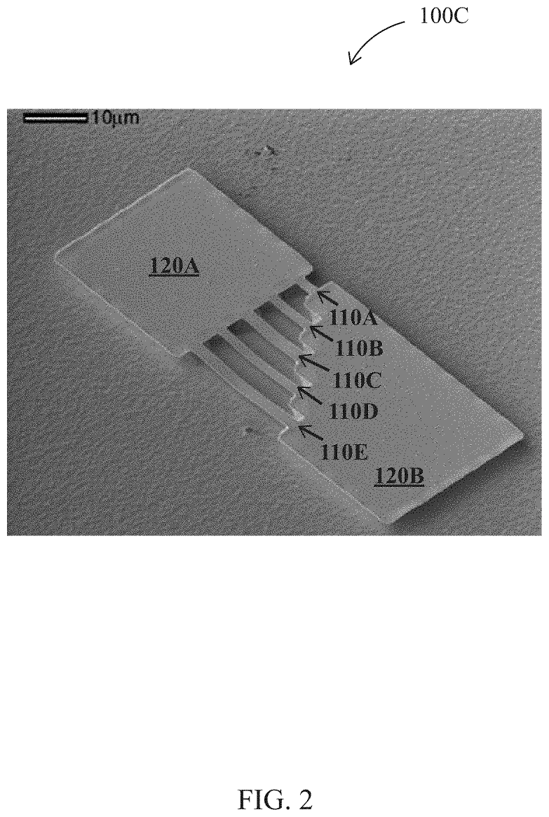

FIG. 1 illustrates single devices, and the present disclosure utilizes an array of such devices to generate a frequency response. An array of MEMS oscillators may include only cantilevers (i.e., the device 100A shown in FIG. 1), only bridges (i.e., the device 100B shown in FIG. 2), or a combination of cantilevers and bridges.

FIG. 2 illustrates an exemplary device 100C (i.e., an array of MEMS bridge oscillators designed to create a PUF) according to some aspects of the present disclosure. In this example, the device 100C includes five MEMS bridge oscillators (110A-110E) positioned between a first anchor 120A and a second anchor 120B. In this device 100C, different resonance frequencies are obtained by the different lengths of each oscillator 110 positioned between the two anchors 120, much like the strings of a guitar or harp. Additionally, when the device 100C is excited or activated, the oscillators 110 may couple, resulting in the device 100C having a frequency that is different than simply the sum of the frequency of each oscillator 110. The photograph shown in FIG. 2 was taken using a scanning electron microscope (SEM), demonstrating the small scale of the device 100C. Each oscillator 110 has a width of approximately 3 μm and a thickness of approximately 200 nm. The lengths are 4 μm (110A), 7 μm (110B), 10 μm (110C), 12 μm (110D), and 17 μm (110E). The device 100C is made primarily of silicon. The first anchor 120A is approximately 25 μm wide by approximately 25 μm long and the second anchor 120B is approximately 25 μm wide with a length of approximately 25 μm on the short side (i.e., the side near 110E) and a length of approximately 38 μm on the long side (i.e., the side near 110A). Both anchors 120 have a thickness of approximately 200 nm.

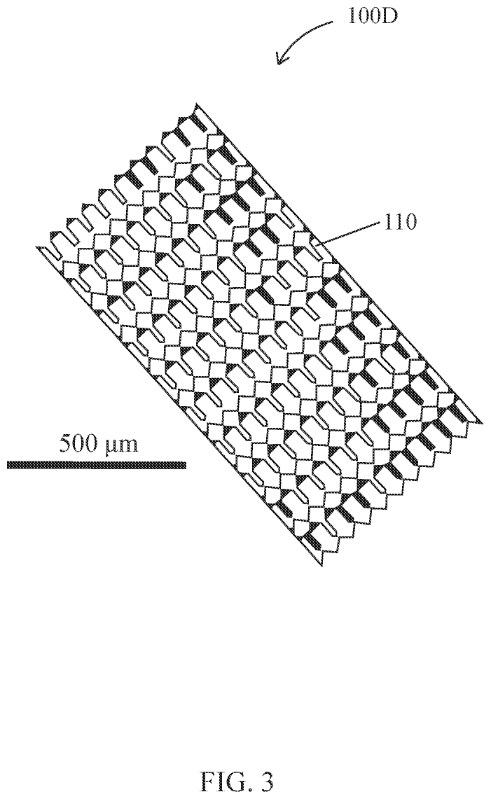

FIG. 3 illustrates an exemplary device 100D (i.e., an array of MEMS cantilever oscillators designed to create a PUF), according to some aspects of the present disclosure. In this example, the device 100D includes a plurality of oscillators 110 arranged in a two-dimensional (2D) 10×10 array. The area of the device 100D was approximately 700 μm by 2000 μm, with each oscillator 110 having a length between 45 μm to 55 μm, a width of approximately 15 μm, and a thickness of approximately 0.5 μm. The photograph shown in FIG. 3 was taken by a SEM, again demonstrating the small scale of the device 100D. As the oscillators 110 shown in FIG. 3 are cantilever oscillators 110, each individual oscillator 110 is attached to a respective individual anchor.

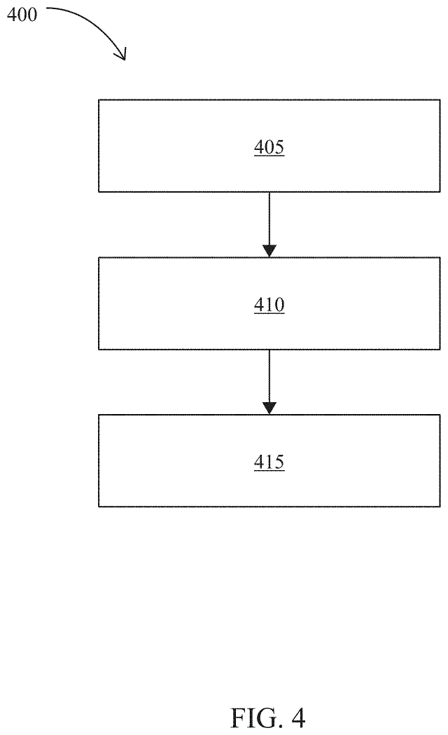

The photograph shown in FIG. 3 shows significant variation in the shading of the oscillators 110. This shading variation is a result of “bending” in the oscillators 110 as a result of the fabricating process (described in FIG. 4). These “bends”, misalignments, or deformations add to the uniqueness of each device 100, further contributing to the difficulty in reproducing the frequency response of the device 100D.

FIG. 4 illustrates a method of creating a unique identifier, according to some aspects of the present disclosure. The method 400 includes first fabricating 405 a device 100 made up of a plurality of oscillators 110. The fabricating 405 may include using single crystal silicon (Si), low stress silicon nitride (SiNx), other silicon oxides, polysilicon, and/or aluminum oxide, to form structural layers in a processing chamber. These layers may be formed using a form of deposition, such as low-pressure chemical vapor deposition (LPVCD). Anisotropic etching of the structural layers may be done to form the individual oscillators 110 within the device 100. In some embodiments, anisotropic etching may be performed using potassium hydroxide (KOH). Given the size of the oscillators 110 and the device 100 overall, creating oscillators 110 to the exact desired dimensions may be difficult to obtain. These microfabrication inaccuracies add to the advantage of using the device 100 to create a unique identifier, as during fabrication would be difficult to predict the exact frequency for each oscillator 110 in the device 100, meaning it would also be difficult to copy.

The method 400 may include adhering 410 a weight on the oscillators 110. The weight may be platinum (Pt), gold (Au), cobalt (Co), silver (Ag), silicon (Si), copper (Cu), nickel (Ni), zinc (Zn), or other similar materials. The weight may be randomly deposited or distributed on the oscillators 110 in a thin film, using resonance vibrations in the oscillators 110 to disperse the weight. In some embodiments, the weight may be applied in a liquid form, then allowed to dewet or “ball up” creating random placement of the weight on the oscillators 110. This dewetting may create random “patterns” of a weight which contribute to the randomness of the frequency response created by the device 100. The resulting pattern or arrangement of a weight may be difficult, if not impossible, to replicate, as it is based on the temperature of the oscillators 110, the material of the weight, the frequency of the oscillators 110, and other factors which may be hard to replicate. In some embodiments, two weights may be co-deposited and then one weight may be selectively removed (i.e., dealloying) to create random placement of weights on the oscillators 110. By using the randomness of the resonance frequency during the microfabrication process the device 100 may be difficult to reverse-engineer, adding to its security.

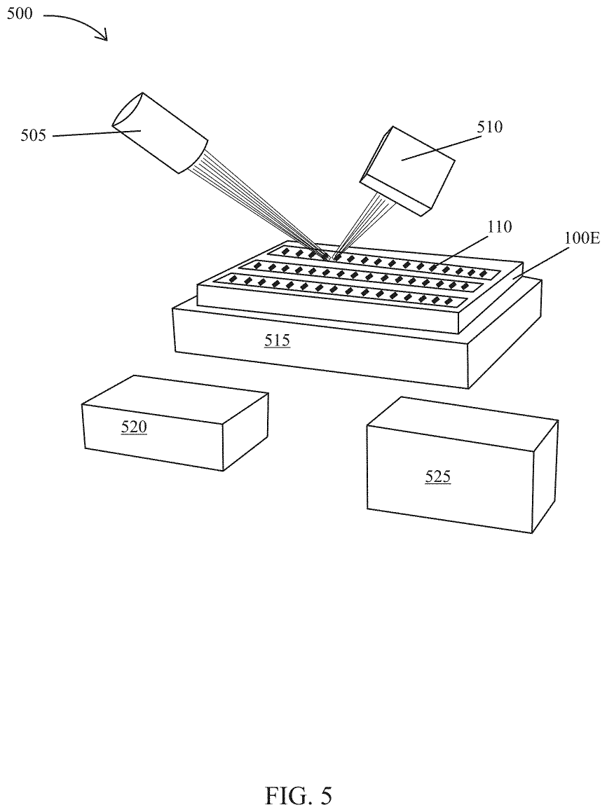

The method 400 includes recognizing 415 a response in the device 100. The recognizing 415 may include measuring the frequency response in the device 100. The recognizing 415 may include exiting the oscillators 110 using optical excitation, ambient excitation, thermal excitation, and/or audio excitation. The recognizing 415 may include detecting the frequency response by generating an optical readout of the frequency response (using a system as shown in FIG. 5).

In some embodiments, the response may be an amplitude and/or the quality (Q)-factor of the oscillator 110. The difficulty of reproducing the values of the response increases exponentially with the number of oscillators 110 in the device 100. This results in a device 100 with responses of oscillators 110 that are difficult to reproduce.

In some embodiments, for a device 100 the frequency response of each oscillator 110 may be significantly affected by the coupling to neighboring oscillators 110 and the collective behavior of the device 100 may impact the performance of an oscillator 110. For such devices 100, the dynamic equation is rather complicated as the oscillators 110 interact with each other via a coupling force. A two-dimensional array of oscillators 110 utilized in some embodiments herein may provide a uniquely encrypted “signature” to each chip based on the frequency response, oscillation amplitude, and Q-factor of each oscillator 110 in the array.

FIG. 5 illustrates a system 500 for determining the unique identifier of a device 100 for creating a unique identifier, according to aspects of the present disclosure. The system 500 includes a laser 505, a detector 510, a crystal 515, a generator 520, and a processor 525. An optical readout created by the system 500 may be used to measure the motion of the oscillators 110 in a device 100E. An optical readout is a visual representation or display of the output (i.e., frequency response) of the device 100E.

In some embodiments, the laser 505 may be a diode laser, a vertical cavity surface emitting laser (VCSEL) array, or a strobe light. In some embodiments, the laser 505 may be a 5 mW diode laser operating at 632 nm with a focusing system. Some embodiments may utilize a “optical-lever” method of reading the unique identifier of the device 100E by focusing the laser 505 on the free end (i.e., the unattached end) of a cantilever oscillator 110.

The detector 510 may be a device to detect the frequency response of the device 100E in response to the stimulus provided by the laser 505. The detector 510 may be a photo detector or camera. In some embodiments, the detector 510 may be a focal plane array (FPA) and infrared camera. In some embodiments, the detector 510 may be a digital single-lens reflex camera. In some embodiments, the detector may be an accelerometer. In some embodiments, the detector 510 may be an optical position sensor, such as a position sensitive device (or position sensitive detector). In some embodiments, the detector 510 may detect a signal reflected by the oscillators 110 of the device 100E in response to the laser 505.

The crystal 515 may be a piezoelectric crystal. In some embodiments, the crystal 515 may be a platform or other support structure. In some embodiments, the crystal 515 may mimic the product for which the device 100E is creating a unique function. For example, if the desired product is a microchip for electronics, the crystal 515 may be electrically conductive.

The generator 520 may be a frequency generator. The generator 520 may be a device to provide a stimulus to the device 100E to illicit a frequency response (i.e., the unique identifier). The generator 520 may be an audio speaker to provide audio stimulus (i.e., create a sound). The generator 520 may be a heat source (such as a space heater) to provide a thermal stimulus. The generator 520 may be a light source to provide a visual stimulus. In some embodiments, the generator 520 may be a piezoelectric speaker (or transducer) capable of acoustically exciting the oscillators 110.

The processor 525 may record the output created by the system 500. In some embodiments, the output may be shown as a photograph. The photograph may be digital in the form of a portable document format (PDF), a joint photographic experts' group (jpeg), portable network graphics (png), tag image file format/electronic photography (TIFF/EP), or another digital medium. The photograph may be printed. In some embodiments, the output may be in the form of frequency measurements (in Hz) for the oscillators 110 or for the device 100 as a whole. In some embodiments, the processor 525 may be a lock-in amplifier or a spectrum analyzer.

To read the unique identifiers, the present disclosure utilizes optical techniques similar to those used in scanning probe microscopy to optically read the oscillators 110 on the devices 100. The low noise level and superior sensitivity of the optical transduction means the resonance frequency may be driven merely by ambient thermal fluctuation (i.e., Brownian motion in air molecules).

An optical readout may be used to monitor the cantilever oscillator 110 motion and measure the frequency response of the device 100. An optical readout may streamline the device 100 fabrication process and facilitate the characterization of the unique identifier without the need of significant additional components to the device 100 or the product for which the unique identifier is needed.

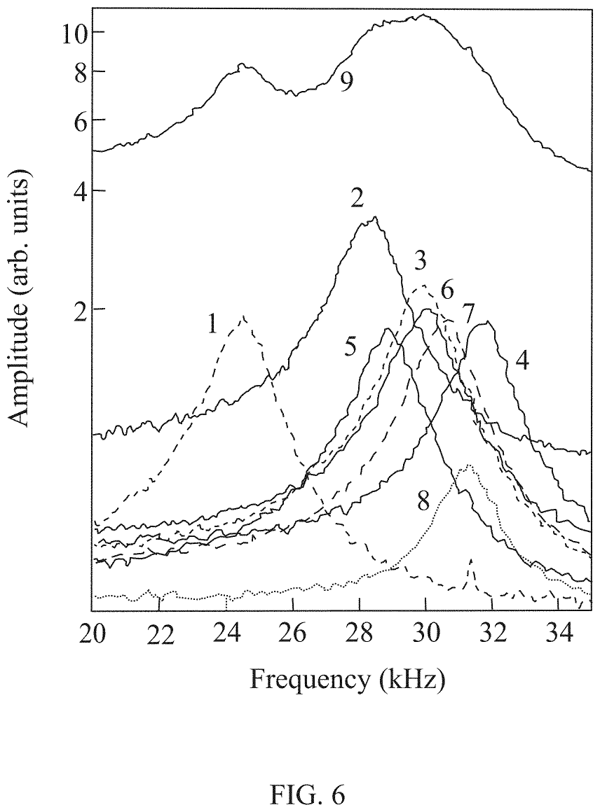

FIG. 6 illustrates responses of oscillators 110 within an exemplary device 100 (shown in FIG. 3) for creating a unique identifier and the total response of the device 100 itself, according to some aspects of the present disclosure. In some embodiments, a device 100 may be exposed to ambient excitation caused by random thermal fluctuations to measure the frequency response. FIG. 6 shows the measured responses over a frequency range of 20 to 35 kHz and amplitude of oscillation as a function of frequency due to ambient excitation of eight cantilever oscillators 110 in a device 100D (shown in FIG. 3). Line 9 represents the total measured signal and lines 1-8 show the individual oscillator 110 resonance frequency curves. Note that Line 9 is not a frequency response for use as a unique identifier, it is the resonance frequency of the device 100D at ambient conditions. Because the ambient excitation forces most (if not all) of the oscillators 110 to undergo Brownian motion, this allows simultaneous measurement of all the responses from most (if not all) of the oscillators 110 within the device 100 at ambient excitation. This allows the measurement of the oscillators 110 responses without the use of an external input (i.e., at ambient excitation). Differences were determined for the resonance frequency value, floor noise, amplitude, and quality (Q)-factor for the oscillators 110. The sum total frequency response is shown in FIG. 6 and was obtained by adding together all the measured individual frequency responses of the oscillators 110. However, the differences in the maximum oscillation amplitude and Q-factor in the oscillators 110 disclosed herein may have resulted in some individual features being lost in FIG. 6. The total amplitude (measured signal) and the number of peaks can provide additional information when designing the encryption.

Using ambient excitation to measure the response of individual oscillators 110 in a device 100 as disclosed herein provides a convenient way to characterize the dynamic behavior with no or minimal interference from neighboring oscillators 110. That is, measuring the frequency response of oscillators 110 due to Brownian motion does not include any interference or coupling from neighboring oscillators. The individual resonance frequencies for a sample of oscillators 110 in the device 100D (shown in FIG. 3) were determined and are in Table 1 along with the corresponding Q-factors.

TABLE 1
Resonance frequencies and Q-factors for a sample of oscillators
within a device 100D for creating a unique identifier

| Oscillator 110 | Resonance Frequency (Hz) | Q-factor |
|---|---|---|
| 1 | 24,508.94 | 1974.5 |
| 2 | 28,369.35 | 1974.5 |
| 3 | 29,842.83 | 1473.4 |
| 4 | 31,728.88 | 1561.8 |
| 5 | 28,870.33 | 1797.6 |
| 6 | 30,019.65 | 1944.9 |
| 7 | 30,609.04 | 1768.1 |
| 8 | 31,227.90 | 1385.2 |

In some embodiments, the size of the oscillators 110 may be very small (i.e., on the microscale), with lengths of 50-500 μm, widths of 10-50 μm, and/or thicknesses of 0.1-4.0 μm. In some embodiments, the oscillators 110 may be even smaller, with lengths of 2-9 μm, widths of 0.1-4 μm, and/or thicknesses of 10-50 nm. In some embodiments, the oscillators 110 may be on the nanoscale, having lengths of 20-1000 nm, widths of 10-200 nm, and/or thicknesses of 10-200 nm. These dimensions are approximate, other similar dimensions may be used. Oscillator 110 behaviors are highly scalable, and in some embodiments, similar principles may be applied to design and fabricate much larger structures.

The size of the device 100 may depend on the number of oscillators 110, the spacing between the oscillators 110, the size of the oscillators 110, and/or the desired product for which the device 100 is creating a unique identifier. For example, in some devices 100, the oscillators may be arranged in a substantially rectangular array (for example, 1×3, 1×4, 1×5, 1×8, 1×12, 8×8, 8×10, 10×10, or other arrangements). In some embodiments, the device 100 may have a total area comparable to a typical metal-oxide-semiconductor (CMOS) chip resonator, which may be a product requiring a unique identifier. Note that the arrays described herein may be substantially grid-like, having the oscillators 110 arranged in rows and columns (i.e., two dimensional), but any formation or organization of the oscillators 110 may be utilized.

In some embodiments, the lengths of oscillators 110 in the device 100 may be varied incrementally (i.e., a same number of μm between lengths of oscillators), resulting in slightly difference behavior of each oscillator 110 due to the length variation and intrinsic variations in the microfabrication process. These different behaviors may include resonance frequency, excitation amplitude, and/or quality (Q)-factor. The values of the measured resonance frequencies may agree reasonably with the expected predicted values based on the desired dimensions and any discrepancies may be due to inaccuracies in the fabrication process. Each of the oscillators 110 in the device 100 may have specific resonance frequency modes and reading out the resonance frequency of the device 100 can provide a spectrum of vibrational frequencies that is unique to each device 100. A piezoelectric transducer (or piezoelectric sensor) may be used to measure resonance frequency.

In some embodiments, the oscillators 110 may be substantially passive resonators, meaning they do not produce energy and require no electrical power to operate. This is because they may resonate (and have a frequency resonance) at ambient conditions (i.e., with ambient excitation). In some embodiments, the oscillators 110 may be made primarily of substantially insulative materials.

In some embodiments, a microfabrication process which aims to produce identical devices 100, may be utilized. However, the resonance frequency of an oscillator 110 can exhibit small but measurable differences even in neighboring oscillators 110 for the same device 100. Such deviations may be large enough to be characterized straightforwardly without a readout using piezoresistive or optical means. This may be from random variations in the MEMS geometry of each oscillator 110 and material properties due to ubiquitous stochastic factors in fabrication steps during the manufacturing process of the device 100. These factors may include minute random temperature variations across the base 130, pressure changes in the processing chambers, variations in chemical composition, heat treatment, grain size, and non-uniformity of deposited coatings.

In some embodiments, the fabrication tools used to generate the device 100 may be substantially the same fabrication tools used to create the product requiring the unique identifier (for example, integrated circuits), meaning the device 100 and the product may be produced substantially simultaneously. For example, in some embodiments, the fabrication process may use single crystal silicon (Si) substrate and be compatible with standard complementary metal-oxide-semiconductor (CMOS) processing to allow the device 100 to be used to create a unique identifier for the CMOS product.

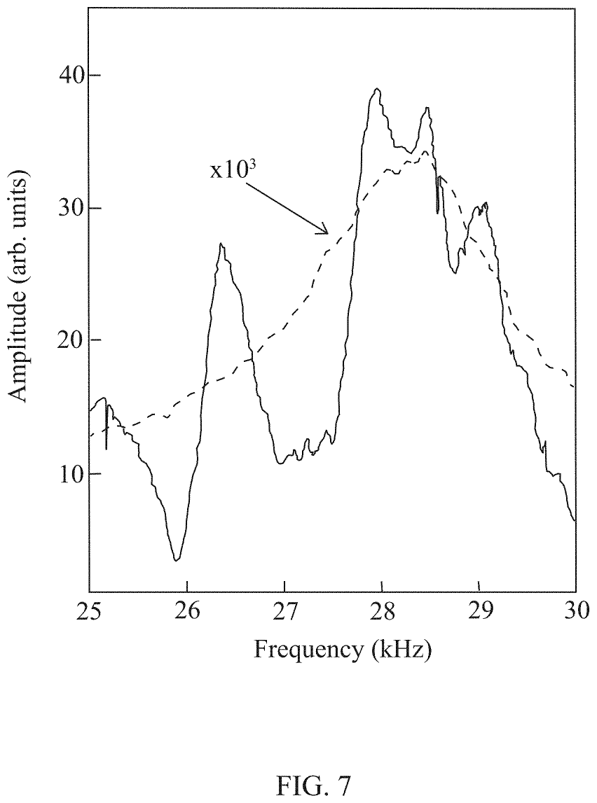

FIG. 7 illustrates a comparison between resonance frequency and frequency response (in response to an audio stimulus) for a device (specifically device 100D shown in FIG. 3) for creating a unique identifier, according to some aspects of the present disclosure. The resonance frequency is shown as a dashed line and the frequency response (to an audio stimulus) is shown as a solid line. The device 100D shown in FIG. 3 was excited using a piezoelectric speaker. The response was measured between 25 and 30 kHz. FIG. 7 illustrates the effect of “coupling” between oscillators 110 on the frequency response of a device 100. The resonance frequency (dashed line) does not include coupling between oscillators. When the device 100D is excited using an external stimulus the oscillators 110 change to a different frequency and begin to influence each other. This influencing or “coupling” is difficult to predict and contributes to the randomness of the unique identifier (i.e., the frequency response) of the device 100.

In some embodiments means of mechanical excitation may be required in place of or in addition to ambient excitation. Depending on the particular geometry and implementation, audio (or acoustic) excitation (as used for the example shown in FIG. 7) may be an effective means of excitation. To the device 100, a piezoelectric speaker was used to acoustically excite the oscillators 110. The frequency response was measured in the range of 25 to 30 kHz using the system 500 described in FIG. 5. A typical measured acoustic frequency response for several of the oscillators 110 is shown in FIG. 7, with the frequency response due to ambient excitation shown for comparison. FIG. 7 shows an acoustic frequency response for the device 100. The frequency response (solid curve) of an oscillator 110 that was excited acoustically. The acoustic excitation source was scanned over a wide range of frequency and the response was measured from 25 to 30 kHz. The frequency response due to ambient excitation is shown as the dashed curve.

The acoustic excitation induces mechanical motion to at least some of the oscillators 110 in the device 100. Therefore, the frequency response of each oscillator 110 may be affected (sometimes significantly) by the mechanical response of the other oscillators 110. Although the optical readout may provide the frequency response of the oscillator 110 that is being interrogated, coupling between the different oscillators 110 and their collective behavior appear to have a noticeable effect in the measured signal of the device 100. This signal may be more pronounced (sometimes significantly so) when each oscillator 110 in the device 100 has a different resonance frequency, especially with a narrow resonance frequency that high-Q factor oscillators 110 can provide. Nonetheless, the measured response tends to be unique to the particular oscillator 110 and the particular device 100. The measured response may be a unique identifier for the device 100. In the testing performed, deliberate efforts to reproduce an identical device 100 were unsuccessful. Reproducing an analogous replica device with identical stochastic distribution of resonance frequencies was not done.

In some embodiments, the devices 100 were interrogated with an optical readout. However, in other embodiments, oscillators 110 which are piezoresistive may be utilized, which may not need an optical access. This may allow all of the oscillators 110 in the device 100 to be measured simultaneously in frequency space, thereby obtaining the spectrum fingerprint within a few resonant frequency cycles.

The methods described herein may be expanded, and based on the array size, may produce a secure cryptographic key of 128, 192, or 256 bits in length and may sustain cryptographic-level authentication. The resulting key may be difficult to reverse engineer, as it may be a read-only system and non-resettable, making it essentially tamper-proof.

The present disclosure includes utilizing variations in resonance frequency in a device 100 as a unique identifier that can be used as an encryption engine. Establishing keys through untrusted networks is one of the most fundamental cryptographic primitives and is typically accomplished using public keys. A typical authentication protocol may involve an enrollment and regeneration process with the enrollment taking place immediately after the manufacturing. The device 100 described herein may serve as a hardware cryptographic primitive to generate a unique key. PUFs are based on a challenge-response pair mechanism that can generate a key without the need for storage. During the registration process described herein, each chip or device may be challenged with seed and configuration parameters. Each chip or device may produce a unique reproducible response/key that serves as a private key. The response along with the configuration parameters may be used to generate a public/private pair.

In some embodiments, the oscillators 110 may be arranged in a two-dimensional (2D) configuration. However, in other embodiments, the arrays may be arranged in a three-dimensional (3D) configuration, thereby providing the potential for an increased encryption while maintaining the required small footprint. Some embodiments may include a mixture of 2D and 3D arrays. Further deliberate stochastic variation in the cantilever masses may be achieved by sputter deposition of a thin film (approximately 5 nm) on individual cantilevers in the array. The variations in the deposition process may result in diversity of individual resonances and, therefore, produce cantilever oscillators 110 with unique distribution of resonance frequencies and Q-factors. A combination of e-beam lithography with wet and dry etching processes may be used for patterning the MEMS arrays. This has the advantage of providing increased resolution and degrees of freedom in “drawing” or “creating” complex shapes and designs of cantilever resonators with fine details. In some embodiments, the details may be as small as 20 nm. Beams with variable cross-sections and nanoscale corrugations may be incorporated into oscillator 110 designs in order to vary nonlinear components of elastic restoring forces.

In some embodiments, the oscillators 110 may act as passive sensors for measuring a variety of different stimuli and the devices 100 could be used as tamper sensors by detecting chemical signature, vibration/grinding, and other potential sources of intrusion. The tamper-sensing mode may be utilized herein as a passive and unpowered mode of the device 100 while sensing and can be read-out when power (i.e., a voltage), or other stimuli, is applied to the device 100. To fully determine the frequency regime, several basic geometries of cantilever oscillators 110 may be evaluated. For approximately the same geometry, the bridge oscillators 110 may have higher frequencies for the first mode compared to cantilever oscillators 110.

### EXAMPLES

### Example 1

A method of creating a unique identifier, the method comprising:
fabricating a plurality of oscillators;
adhering a weight on at least one oscillator within the plurality of oscillators; and
recognizing a response of the plurality of oscillators as the unique identifier; wherein:
the plurality of oscillators comprises at least one of a cantilever or a bridge,
the weight adheres to at least one of the oscillators within the plurality of oscillators, and
the response comprises the frequency of the plurality of oscillators.

### Example 2

The method of Example 1, wherein the fabricating comprises:
depositing at least one structural layer on a base; and
etching the plurality of oscillators within the at least one structural layer; wherein:
the at least one structural layer comprises silicon, and
the etching is performed using anisotropic potassium hydroxide (KOH).

### Example 3

The method of Example 1, wherein the adhering comprises at least one of dewetting or dealloying.

### Example 4

The method of Example 3, wherein dewetting comprises:
depositing a thin film of the weight on at least one oscillator within the plurality of oscillators; and
heating the plurality of oscillators resulting in the adhering of the weight on the at least one oscillator within the plurality of oscillators.

### Example 5

The method of Example 3, wherein dealloying comprises:
depositing the weight on at least one oscillator within the plurality of oscillators; and
selectively removing a portion of the weight resulting in the adhering of the weight on the at least one oscillator within the plurality of oscillators.

### Example 6

The method of Example 1, wherein the weight comprises at least one of platinum (Pt), silver (Ag), gold (Au), silicon (Si), zinc (Zn), copper (Cu), or cobalt (Co).

### Example 7

The method of Example 1, wherein:
each oscillator within the plurality of oscillators comprises a length, a width, and a thickness.

### Example 8

The method of Example 7, wherein the length ranges from 50-500 μm.

### Example 9

The method of Example 7, wherein the length ranges from 2-9 μm.

### Example 10

The method of Example 7, wherein the length ranges from 20-1000 nm.

### Example 11

The method of Example 7, wherein the width ranges from 10-50 μm.

### Example 12

The method of Example 7, wherein the width ranges from 0.1-4.0 μm.

### Example 13

The method of Example 7, wherein the width ranges from 10-200 nm.

### Example 14

The method of Example 7, wherein the thickness ranges from 0.1-4.0 μm.

### Example 15

The method of Example 7, wherein the thickness ranges from 10-50 nm.

### Example 16

The method of Example 7, wherein the thickness ranges from 10-200 nm.

### Example 17

The method of Example 7, wherein the plurality of oscillators does not have a uniform length.

### Example 18

The method of Example 7, wherein the plurality of oscillators does not have a uniform width.

### Example 19

The method of Example 7, wherein the plurality of oscillators does not have a uniform thickness.

### Example 20

The method of Example 1, wherein the recognizing comprises:
measuring a frequency response of the plurality of oscillators.

### Example 21

The method of Example 20, wherein the measuring comprises:
exciting the plurality of oscillators using an external stimulus resulting in the frequency response; and
detecting the frequency response of the plurality of oscillators.

### Example 22

The method of Example 21, wherein the detecting comprises:
generating an optical readout of the frequency response.

### Example 23

The method of Example 22, wherein the generating comprises:
using at least one laser to illuminate the plurality of oscillators; and
capturing the frequency response using a detector capable of showing the optical readout.

### Example 24

The method of Example 23, wherein the detector is a camera and the optical readout is a photograph.

### Example 25

The method of Example 23, wherein the at least one laser is a 5 mW diode laser.

### Example 26

The method of Example 21, wherein the external stimulus comprises a light source.

### Example 27

The method of Example 21, wherein the external stimulus comprises a piezoelectric speaker.

### Example 28

The method of Example 21, wherein the external stimulus comprises a heat source.

### Example 29

A device for creating a unique identifier, the device comprising:
a plurality of oscillators; and
a weight attached to at least one oscillator within the plurality of oscillators; wherein:
the device is configured to generate a frequency response as a result of an external stimulus, and
the frequency response is the unique identifier.

### Example 30

The device of Example 29, wherein each oscillator within the plurality of oscillator comprises a length, a width, and a thickness.

### Example 31

The device of Example 29, wherein the length ranges from 50-500 μm.

### Example 32

The device of Example 29, wherein the length ranges from 2-9 μm.

### Example 33

The device of Example 29, wherein the length ranges from 20-1000 nm.

### Example 34

The device of Example 29, wherein the width ranges from 10-50 μm.

### Example 35

The device of Example 29, wherein the width ranges from 0.1-4.0 μm.

### Example 36

The device of Example 29, wherein the width ranges from 10-200 nm.

### Example 37

The device of Example 29, wherein the thickness ranges from 0.1-4.0 μm.

### Example 38

The device of Example 29, wherein the thickness ranges from 10-50 nm.

### Example 39

The device of Example 29, wherein the thickness ranges from 10-200 nm.

### Example 40

The device of Example 29, wherein the plurality of oscillators does not have a uniform length.

### Example 41

The device of Example 29, wherein the plurality of oscillators does not have a uniform width.

### Example 42

The device of Example 29, wherein the plurality of oscillators does not have a uniform thickness.

### Example 43

The device of Example 29, wherein the weight comprises at least one of platinum (Pt), silver (Ag), gold (Au), silicon (Si), zinc (Zn), copper (Cu), or cobalt (Co).

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method of creating a unique identifier, the method comprising:
fabricating a plurality of oscillators;
adhering a weight on at least one oscillator within the plurality of oscillators; and
recognizing a response of the plurality of oscillators as the unique identifier; wherein:
the plurality of oscillators comprises at least one of a cantilever or a bridge,
the weight adheres to at least one of the oscillators within the plurality of oscillators, and
the response comprises the frequency of the plurality of oscillators.

2. The method of claim 1, wherein the fabricating comprises:
depositing at least one structural layer on a base; and
etching the plurality of oscillators within the at least one structural layer; wherein:
the at least one structural layer comprises silicon, and
the etching is performed using anisotropic potassium hydroxide (KOH).

3. The method of claim 1, wherein the adhering comprises at least one of dewetting or dealloying.

4. The method of claim 3, wherein dewetting comprises:
depositing a thin film of the weight on at least one oscillator within the plurality of oscillators; and
heating the plurality of oscillators resulting in the adhering of the weight on the at least one oscillator within the plurality of oscillators.

5. The method of claim 3, wherein dealloying comprises:
depositing the weight on at least one oscillator within the plurality of oscillators; and
selectively removing a portion of the weight resulting in the adhering of the weight on the at least one oscillator within the plurality of oscillators.

6. The method of claim 1, wherein the weight comprises at least one of platinum (Pt), silver (Ag), gold (Au), silicon (Si), zinc (Zn), copper (Cu), or cobalt (Co).

7. The method of claim 1, wherein:
each oscillator within the plurality of oscillators comprises a length, a width, and a thickness.

8. The method of claim 7, wherein the plurality of oscillators does not have a uniform length.

9. The method of claim 7, wherein the plurality of oscillators does not have a uniform width.

10. The method of claim 7, wherein the plurality of oscillators does not have a uniform thickness.

11. The method of claim 1, wherein the recognizing comprises:
measuring a frequency response of the plurality of oscillators.

12. The method of claim 11, wherein the measuring comprises:
exciting the plurality of oscillators using an external stimulus resulting in the frequency response; and
detecting the frequency response of the plurality of oscillators.

13. The method of claim 12, wherein the detecting comprises:
generating an optical readout of the frequency response.

14. The method of claim 13, wherein the generating comprises:
using at least one laser to illuminate the plurality of oscillators; and
capturing the frequency response using a detector capable of showing the optical readout.

15. A device for creating a unique identifier, the device comprising:
a plurality of oscillators; and
a weight attached to at least one oscillator within the plurality of oscillators; wherein:
the device is configured to generate a frequency response as a result of an external stimulus, and
the frequency response is the unique identifier.
